(19) United States
(12) Patent Application Publication
(10) Pub. No.: US 2011/0317773 A1
(43) Pub. Date: Dec. 29, 2011

(54) METHOD FOR DOWNSAMPLING IMAGES

(75) Inventor: Gregory K. Lancaster, Calgary (CA)

(73) Assignee: Worldplay (Barbados) Inc., Bridgetown (BB)

(21) Appl. No.: 12/822,849

(22) Filed: Jun. 24, 2010

(51) Int. Cl. H04N 7/68; H04N 7/26

(52) U.S. Cl. 375/240.27; 375/E07.188; 375/E07.281

(57) ABSTRACT

Advantage is taken of the concept of Newton iteration to iteratively generate error-corrected downsampled images such that when upsampled with a specified upsampler, the final result very closely matches the original full-resolution image. An implementation of this method requires a target upsampling method for which results are to be optimized (for example, a bicubic upsampler); a downsampling method appropriate for the required downsampling ratio (for example, a bilinear downsampler); an error measure method for determining how closely an upscaled result image matches the original image; and a stopping criterion.

### CROSS-REFERENCE TO RELATED APPLICATIONS

This application is related to commonly owned patent application SYSTEMS AND METHODS FOR HIGHLY EFFICIENT VIDEO COMPRESSION USING SELECTIVE RETENTION OF RELEVANT VISUAL DETAIL, U.S. patent application Ser. No. 12/176,374, filed on Jul. 19, 2008, Attorney Docket No. 54729/P012US/10808779; SYSTEMS AND METHODS FOR DEBLOCKING SEQUENTIAL IMAGES BY DETERMINING PIXEL INTENSITIES BASED ON LOCAL STATISTICAL MEASURES, U.S. patent application Ser. No. 12/333,708, filed on Dec. 12, 2008, Attorney Docket No. 54729/P013US/10808780; VIDEO DECODER, U.S. patent application Ser. No. 12/638,703, filed on Dec. 15, 2009, Attorney Docket No. 54729/P015US/11000742 and concurrently filed, co-pending, commonly owned patent applications SYSTEMS AND METHODS FOR HIGHLY EFFICIENT COMPRESSION OF VIDEO, U.S. patent application Ser. No. ______, Attorney Docket No. 54729/P016US/11000746; DECODER FOR MULTIPLE INDEPENDENT VIDEO STREAM DECODING, U.S. patent application Ser. No. ______, Attorney Docket No. 54729/P018US/11000748; SYSTEMS AND METHODS FOR CONTROLLING THE TRANSMISSION OF INDEPENDENT BUT TEMPORALLY RELATED ELEMENTARY VIDEO STREAMS, U.S. patent application Ser. No. ______, Attorney Docket No. 54729/P019US/11000749; SYSTEMS AND METHODS FOR ADAPTING VIDEO DATA TRANSMISSIONS TO COMMUNICATION NETWORK BANDWIDTH VARIATIONS, U.S. patent application Ser. No. ______, Attorney Docket No. 54729/P020US/11000750; and SYSTEM AND METHOD FOR MASS DISTRIBUTION OF HIGH QUALITY VIDEO, U.S. patent application Ser. No. ______, Attorney Docket No. 54729/P021US/11000751 all of the above-referenced applications are hereby incorporated by reference herein.

### TECHNICAL FIELD

This disclosure relates to downsampling processes and more particularly to systems and methods for using iterative refinement techniques as part of the downsampling process.

### BACKGROUND OF THE INVENTION

In image and video processing, images may be represented at many different resolutions—typically denoted by the number of pixels (samples) used to represent the image (i.e., image width×image height). The process of converting a sampled image from one resolution to another is generally termed resampling, and the process of converting a sampled image to a lower resolution is termed downsampling, or subsampling. Downsampling inherently reduces the amount of data required to represent an image, and so may be used to reduce associated storage, transmission, processing, or display requirements. Downsampling also inherently reduces the detail and information content of an image, so a downsampled image will generally appear to be more blurry to a human viewer than the original higher-resolution image if both images are displayed at the same overall physical size (i.e., in which case the individual pixels of the displayed downsampled image would be larger than those of the original, and thus be unable to represent fine detail). For a particular resolution reduction, the nature of the downsampling method determines the quality, as perceived by the human visual system (HVS), of the rendered image.

Many methods exist for downsampling images. These methods have a wide variety of quality characteristics. A very simple but low-quality downsampling method is Nearest-Neighbor. Higher quality techniques are generally based on higher-order sampling/interpolation methods (bilinear, bicubic, Lanczos, etc.). Usually, downsampler selection is based on a balance between computational cost and the desired visual appeal of the rendered downsampled images. In some situations, other criteria exist. For the concepts discussed in the above-identified co-pending patent application SYSTEMS AND METHODS FOR HIGHLY EFFICIENT COMPRESSION OF VIDEO, the primary criteria are 1) the upsampled version of the downsampled image is very close to the original input image, and 2) the process must be computationally efficient for a high-volume application, such as video stream processing.

One known method that would achieve both goals is the sinc filter. While accurate (i.e., will yield high quality upon upsampling), this method is computationally very expensive and is an idealized filter which can only be approximated for finite image resolutions. It is generally considered to be impractical for real time applications such as video stream processing.

### BRIEF SUMMARY OF THE INVENTION

Advantage is taken of the concept of Newton iteration to iteratively generate error-corrected downsampled images such that when upsampled with a specified upsampler, the final result very closely matches the original full-resolution image.

An implementation of this method requires a target upsampling method for which results are to be optimized (for example, a bicubic upsampler); a downsampling method appropriate for the required downsampling ratio (for example, a bilinear downsampler); an error measure method for determining how closely an upscaled result image matches the original image; and a stopping criterion.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a method for downsampling video images; and

FIG. 2 shows one embodiment of a downsampler in which the method of FIG. 1 is employed.

### DETAILED DESCRIPTION OF THE INVENTION

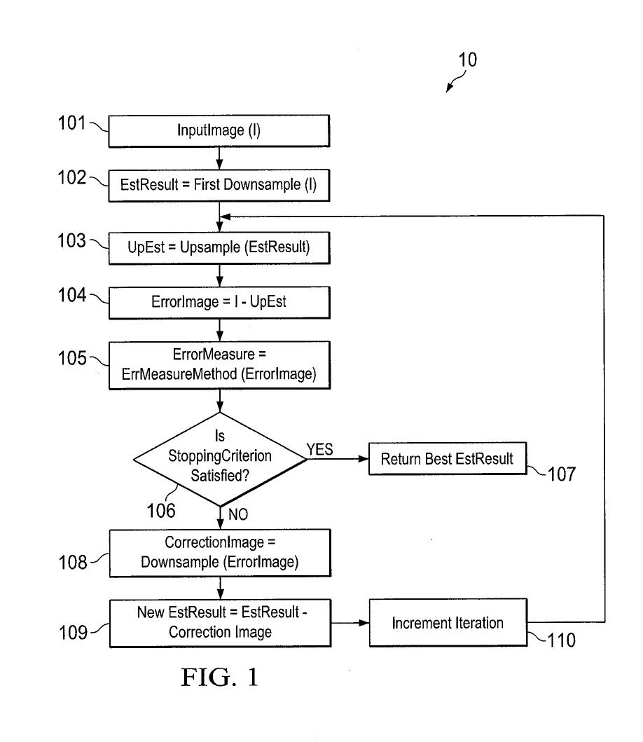

FIG. 1 shows one embodiment of method 10 for downsampling streaming video images. Process 101 accepts the input image I and process 102 creates an initial estimated result by downsampling input image I with an arbitrary downsampling method to create first downsample I. The accuracy of the selected downsampling method is not critical, although convergence will generally improve if a high quality downsampling method is used.

Process 103 upsamples said first downsample of said image stream (estimated result) to the same resolution as the original image, using the target upsampling method. This results in a first upsample estimated result.

Process 104 subtracts the upsampled estimated result from the original image I to create an ‘error image’ indicating the per-pixel error

Process 105 calculates the ‘error measure’ from the error image, according to the specified error measure method. Typical error measure methods include maximum absolute difference, average absolute difference, or average squared difference. The error measure is a single scalar number representing the degree of difference between the upsampled estimated result and the original image.

Process 106 determines if the stopping criterion has been satisfied. The stopping criterion can be any process which, given the error measure and the current iteration number, will determine whether it is time to terminate the process. Examples of stop criterion are: if a certain iteration number, say 3, has been met; or if the error measurement is under a certain value, say 5; or if the error measurement is diverging instead of converging.

If the stopping criterion of process 106 is satisfied then process 107 provides the best estimated result obtained so far. Other stopping criteria might be, when a specified error measure has been met, or when the error measure increases over an iteration.

If the stopping criterion of process 106 is not satisfied, then process 109 downsamples the error image to the same resolution as the estimated result. This is accomplished by using a downsampler of sufficiently high order such that it will consider all the high-resolution source pixels that overlap the destination low-resolution pixel. The result is a “correction image”.

Process 109 subtracts the correction image from the estimated result, to produce a newly refined estimated result. Process 110 increments the iteration number and the New EstResult is then used in process 103.

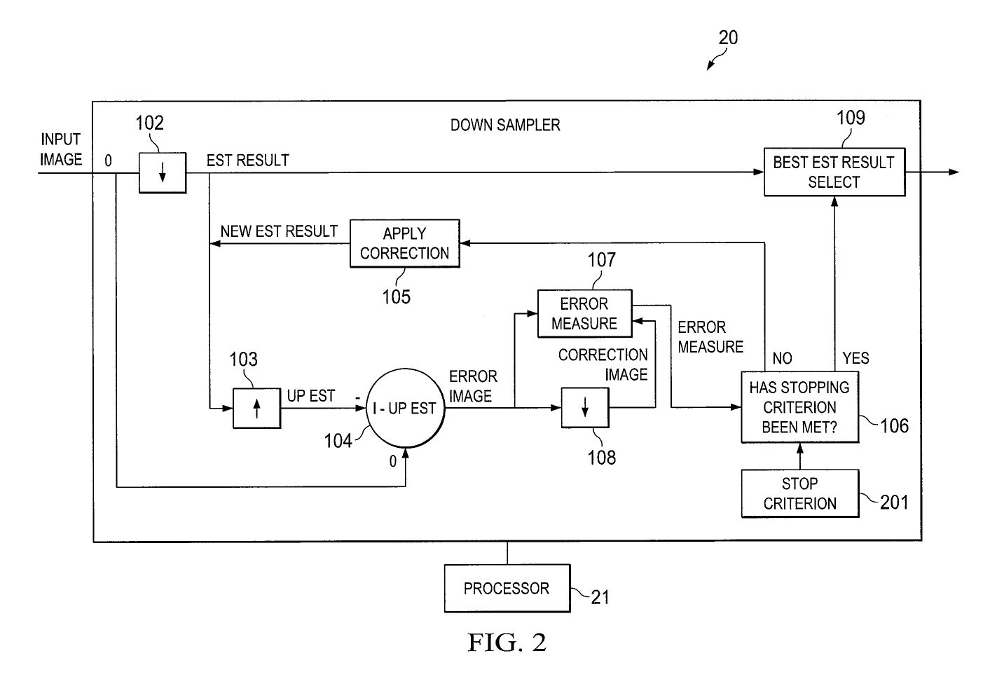

FIG. 2 shows one embodiment of a downsampler, such as downsampler 20, in which the method of FIG. 1 is employed. In the embodiment shown, the elements of device 20 function as discussed above under control of a processor, such as processor 21. The processor could be controlled by code under control of a software application resident in a memory (not shown). If desired, downsampler 20 can be controlled by firmware or implemented as an ASIC if desired. Note that downsampler 102 and downsampler 108 could, if desired, be the same downsampler with inputs and outputs being redirected as required. In the embodiment shown, ErrorMeasure 107 is separate from downsampler 108 which is applied to the ErrorImage. ApplyCorrection 105 is applied to the combination of the current EstResult and the CorrectionImage. The resulting New EstResult is sent back to the beginning (upscaler 103) if the stopping criterion has not been met. The best EstResult observed over all iterations is captured by Best EstResult Select 109 and returned from the system when the stopping criterion has been met.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for downsampling a video image stream, said method comprises:
downsampling a received video image stream to obtain a first downsampled result;
upsampling said first downsampled result to obtain a first upsample image;
obtaining a first error measurement between said received video image and said first upsample image;
determining if a stop criterion has been reached;
if said stop criterion has been reached then use said first downsampled result as a downsampled video image stream;
if said stop criterion has not been reached, then downsample said first upsample image to obtain a correction downsample image and using said correction downsample image iterate said upsampling, said obtaining and determining until said stop criterion has been reached.

2. The method of claim 1 where said first error measurement comprises:
subtracting said first upsample image from said received video image.

3. The method of claim 1 wherein said stop criterion is selected from the list of:
a certain number of iterations has occurred; said error measurement is under a certain value; said error measurement is diverging instead of converging.

4. A downsampler comprising:
means for downsampling an input image;
means for upsampling a downsampled image;
means for generating an error measurement between said input image and said upsampled image; and
means controlled, at least in part by said error measurement, for providing said downsampled image as an output only when certain criterion have been met.

5. The downsampler of claim 4 wherein said generating means comprises:
means for subtracting said upsampled image from said input image.

6. The downsampler of claim 4 wherein said certain criterion are selected from the list of: a certain number of iterations has occurred; said error measurement is under a certain value; said error measurement is diverging instead of converging.

7. A downsampling system comprising:
at least one downsampler;
an upsampler; and
a criterion determinator for allowing an output from at least one of said downsampler only when a certain criterion has been achieved.

8. The system of claim 7 further comprising:
an error measurement process circuit for determining an error measurement between an input video image and a downsampled video image.

9. The system of claim 8 wherein said certain criterion are selected from the list of:
a certain number of iterations has occurred; said error measurement is under a certain value; said error measurement is diverging instead of converging.

10. A method of providing downsampling for a streaming video input; said method comprising:
providing an error measurement between said streaming video input image and an up sampled video image created from a video image previously downsampled from said streaming video input image; and
using said error measurement together with other criteria to either further iterate said providing or allow said video image previously downsampled from said streaming video input image to become an output image.

11. The method of claim 10 where said error measurement comprises:
subtracting said upsampled image from said input video image.

12. The method of claim 11 wherein other criterion are selected from the list of:
a certain number of iterations has occurred; said error measurement is under a certain value; said error measurement is diverging instead of converging.
